(19) United States
(12) Patent Application Publication
(10) Pub. No.: US 2010/0141629 A1
(43) Pub. Date: Jun. 10, 2010

(54) IMAGE DISPLAY APPARATUS WITH IMPROVED SAFETY OF ELECTRIC POWER SUPPLY TO ILLUMINATION DEVICE AND CONTROL METHOD THEREOF

(75) Inventors: Kazunori Kotani, Nara-shi (JP); Hirofumi Kazumori, Kizugawa-shi (JP); Shigeyuki Hashizume, Shijonawate-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/626,186

(22) Filed: Nov. 25, 2009

(30) Foreign Application Priority Data
Dec. 5, 2008 (JP) 2008-310974

(51) Int. Cl. G09G 5/00

(52) U.S. Cl. 345/211

(57) ABSTRACT

An image display apparatus includes a control unit for controlling a manner of supplying electric power from a power supply unit to an illumination device, and a detection unit included in a control system independent of the control unit. The detection unit detects whether or not a component of the image display apparatus assumes a state satisfying a condition on which electric power is supplied to the illumination device. When the control unit outputs a signal to the power supply unit for causing the power supply unit to supply electric power to the illumination device, and the detection unit detects that the component assumes the state satisfying the condition, supply of electric power to the illumination device is permitted.

### BACKGROUND OF THE INVENTION

1. Field of the Invention

The present invention relates to an image display apparatus, and particularly to an image display apparatus having an illumination device to which electric power is supplied with improved safety, and a method of controlling the image display apparatus.

2. Description of the Background Art

In an image display apparatus such as projector, an illumination device such as lamp is required to be supplied with electric power of a relatively high voltage. In order to address requirements such the above-described one, various techniques have been disclosed for controlling turn-on and turn-off of an illumination device.

Document 1 (Japanese Patent Laying-Open No. 05-234686) for example discloses a technique according to which respective voltage values at a plurality of points on an electric circuit are detected for sensing an abnormality of the circuit including an illumination device. The technique as disclosed in this publication provides a plurality of analog switches, and the position where the voltage value is to be detected is changed by changing a manner of turning on and off these analog switches.

Document 2 (Japanese Patent Laying-Open No. 11-204286) discloses a technique concerning a discharge lamp lighting apparatus, according to which the state of oscillation of an oscillation control circuit is controlled so that the output of a high frequency power supply for supplying electric power to a discharge lamp is changed, an abnormality detection circuit is provided for detecting the lighting state of the discharge lamp and, when it is determined that the lighting state is abnormal, the output of the high frequency power supply is stopped.

Document 3 (Japanese National Patent Publication No. 2007-521615) discloses a technique according to which control of an electronic ballast for supplying electric power to a lamp includes current sense feedback for detecting overcurrent conditions and lamp faults.

Document 4 (Japanese Patent Laying-Open No. 2000-292857) discloses a technique concerning a projection type image display apparatus, according to which notice of abnormality is given by means of sound. Specifically, when a microcomputer detects that a lamp goes out, a sound signal corresponding to the fact that the lamp goes out is generated for giving notice of abnormality.

Document 5 (Japanese Patent Laying-Open No. 2004-157201) discloses a technique concerning a projector apparatus, according to which the lighting state of a light source is monitored based on the operating state of lighting circuit means and, when a trouble occurs to the light source, light source switch means is caused to start an operation of switching the light source to another one.

In the conventional image display apparatuses, control of the operation of supplying electric power to an illumination device is centralized in a control unit such as microcomputer or IC (Integrated Circuit).

Therefore, if the control unit malfunctions, electric power could be supplied to the illumination device even if the electric power should not be supplied to the illumination device in such a case where an abnormality occurs to another neighboring component in the image display apparatus, for example.

### SUMMARY OF THE INVENTION

The present invention has been made in view of the circumstances above, and an object of the invention is to ensure that erroneous supply of electric power to an illumination device of an image display apparatus is avoided even when a control unit malfunctions.

An image display apparatus according to the present invention includes: an illumination device; a power supply unit for supplying electric power to the illumination device; a control unit for controlling a manner of supplying electric power from the power supply unit to the illumination device; a detection unit independent of the control unit for detecting whether a component of the image display apparatus assumes a state satisfying a condition on which electric power is supplied to the illumination device; and a permission unit permitting supply of electric power to the illumination device when the control unit outputs to the power supply unit a signal for causing the power supply unit to supply electric power to the illumination device and the detection unit detects that the component assumes the state satisfying the condition.

A method of controlling an image display apparatus according to the present invention is a method of controlling an image display apparatus including an illumination device, a power supply unit for supplying electric power to the illumination device and a control unit for controlling a manner of supplying electric power from the power supply unit to the illumination device, and the method includes the steps of: determining whether the control unit outputs to the power supply unit a signal for causing the power supply unit to supply electric power to the illumination device; detecting whether a component of the image display apparatus assumes a state satisfying a condition on which electric power is supplied to the illumination device, by means of a control system independent of the control unit; and supplying electric power from the power supply unit to the illumination device when the control unit outputs the signal to the power supply unit and the component assumes the state satisfying the condition.

According to the present invention, the detection unit included in a control system independent of the control unit for controlling the manner of supplying electric power from the power supply unit to the illumination device detects whether or not a component of the image display apparatus assumes a state satisfying a condition on which electric power is supplied to the illumination device. Even when the control unit outputs the signal to the power supply unit for causing the power supply unit to supply electric power to the illumination device, supply of electric power from the power supply unit to the illumination device is not permitted unless the detection unit detects that the component assumes the state satisfying the condition as described above.

In other words, based on not only the signal from the control unit but the result of detection by the control system independent of the control unit, whether supply of electric power to the illumination device is permitted or inhibited is determined.

Thus, an abnormal state of another component in the image display apparatus detected by the detection unit can surely be reflected on control of electric power supply to the illumination device.

Further, the state of the component as described above, as detected by the control system independent of the control unit, is provided not to the control unit but directly to the permission unit for use in determining whether electric power supply to the illumination device is permitted or inhibited.

Accordingly, even if the control unit malfunctions, electric power supply to the illumination device can surely be avoided when an abnormality occurs to the component as described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a configuration of a main portion of a projector implemented as an embodiment of an image display apparatus of the present invention.

FIG. 2 is a control block diagram of the projector in FIG. 1.

### DESCRIPTION OF THE PREFERRED EMBODIMENTS

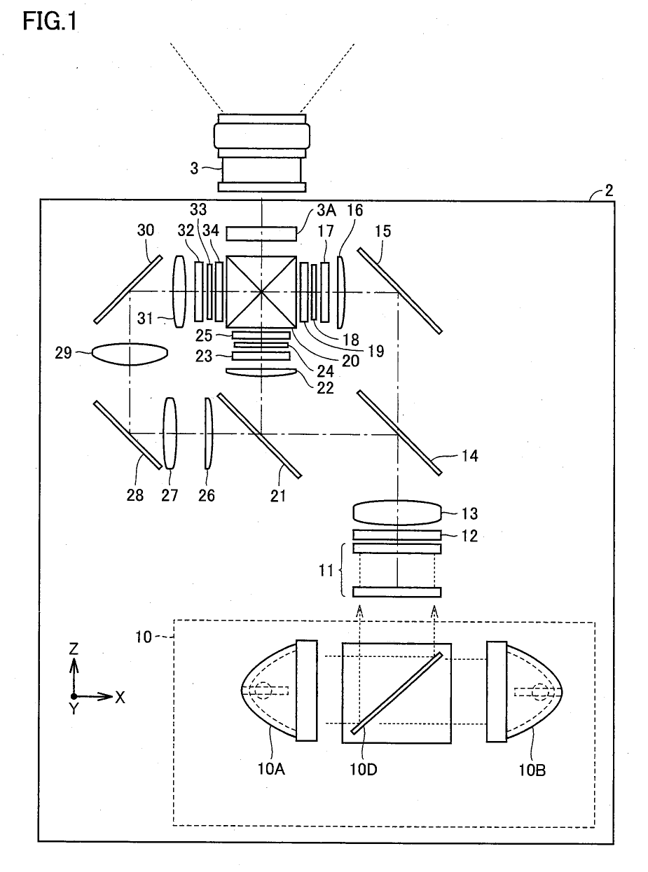

Referring to FIG. 1, a projector includes an optical engine 2 and a projection lens 3, and the outside of the projector is covered with a casing (not shown). While the projector includes, for example, a component for audio output such as speaker, and a circuit board for electrically controlling the components of optical engine 2 and the audio output means, a part of the components including the aforementioned ones of the projector is not shown in FIG. 1.

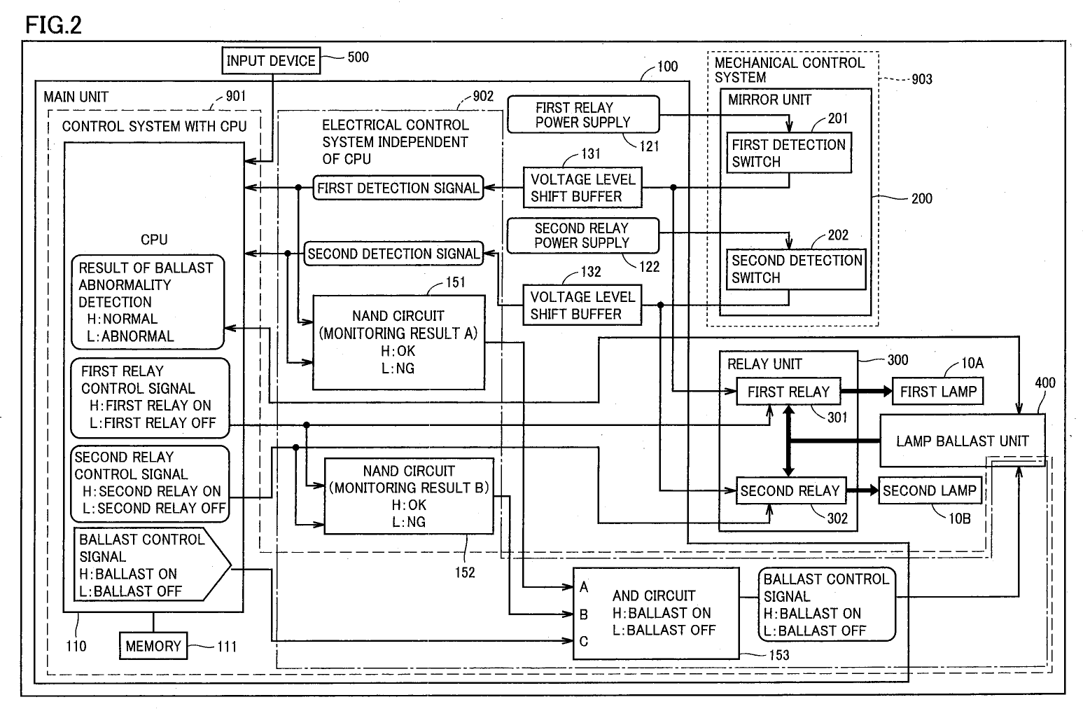

Optical engine 2 includes an illumination device 10. Illumination device 10 includes two lamps 10A, 10B and a mirror unit (mirror unit 200 shown in FIG. 2) for driving a mirror 10D, for example. Lamps 10A, 10B may be, for example, ultra-high pressure mercury lamp, metal halide lamp or xenon lamp. Light from lamps 10A, 10B is emitted in the form of substantially parallel light rays by the action of a reflector.

Mirror 10D is rotatable in parallel with the X-Z plane in FIG. 1. When lamp 10A is actuated, mirror 10D is caused to assume the state for directing the light from lamp 10A to a fly-eye integrator 11 as shown in FIG. 1. When lamp 10B is actuated, mirror 10D is rotated clockwise by 90° about the Y axis as the rotational axis in FIG. 1 to assume the state for directing the light from lamp 10B to fly-eye integrator 11.

The light emitted from illumination device 10 proceeds via fly-eye integrator 11 to enter a PBS (polarized beam splitter) array 12 and a condenser lens 13. Fly-eye integrator 11 includes a fly-eye lens constituted of a group of lenses that appears to be an eye of a fly, and optically acts on the light from illumination device 10 so that the distribution of the quantity of light incident on liquid crystal panels 18, 24, 33 is uniform.

PBS array 12 is constituted of a plurality of PBSs and half-wave plates that are arranged in the form of an array, and causes the light rays from fly-eye integrator 11 to travel in one direction of polarization. Condenser lens 13 concentrates the light from PBS array 12. The light traveling through condenser lens 13 is then incident on a dichroic mirror 14.

Dichroic mirror 14 transmits only the light in the blue wavelength range (hereinafter “B light”), of the light from condenser lens 13, and reflects the light in the red wavelength range (hereinafter “R light”) and the light in the green wavelength range (hereinafter “G light”). The B light passing through dichroic mirror 14 is directed to and reflected by a mirror 15 and enters a condenser lens 16.

Condenser lens 16 optically acts on the B light so that the B light is incident on liquid crystal panel 18 in the form of substantially parallel light rays. The B light passing through condenser lens 16 is incident on liquid crystal panel 18 via an entry side polarization plate 17. Liquid crystal panel 18 is addressed according to an image signal for the blue color, and modulates the B light according to the addressed state. The B light modulated by liquid crystal panel 18 travels via an exit side polarization plate 19 to enter a dichroic prism (the term may be simply referred to as “prism” hereinafter) 20.

Of the light reflected by dichroic mirror 14, the G light is reflected by a dichroic mirror 21 to enter a condenser lens 22. Condenser lens 22 optically acts on the G light so that the G light is incident on liquid crystal panel 24 in the form of substantially parallel light rays. The G light passing through condenser lens 22 is incident on liquid crystal panel 24 via an entry side polarization plate 23. Liquid crystal panel 24 is addressed by an image signal for the green color and modulates the G light according to the addressed state. The G light modulated by liquid crystal panel 24 travels via an exit side polarization plate 25 to enter dichroic prism 20.

The R light traveling through dichroic mirror 21 enters a condenser lens 26. Condenser lens 26 optically acts on the R light so that the R light is incident on liquid crystal panel 33 in the form of substantially parallel light rays. The R light passing through condenser lens 26 proceeds along an optical path including relay lenses 27, 29, 31 for adjusting the optical path length and two mirrors 28, 30, and is incident on liquid crystal panel 33 via an entry side polarization plate 32. Liquid crystal panel 33 is addressed according to an image signal for the red color and modulates the R light according to the addressed state. The R light modulated by liquid crystal panel 33 travels via an exit side polarization plate 34 to enter dichroic prism 20.

Dichroic prism 20 combines the B light, G light and R light modulated respectively by liquid crystal panels 18, 24 and 33 into colored composite light, and causes the light to enter projection lens 3. Projection lens 3 includes a group of lenses for projecting the light to form an image on a projection plane, and an actuator for shifting a part of the lenses in the direction of the optical axis so as to adjust the state of zooming and the state of focusing an image to be projected. The colored composite light generated by dichroic prism 20 is enlarged and projected on a screen by projection lens 3.

In the projector of the present embodiment, a shutter 3A is disposed between projection lens 3 and dichroic prism 20. The projector of the present embodiment can close shutter 3A to hinder the light generated by lamp 10A or lamp 10B from being emitted via projection lens 3 to the outside.

FIG. 2 is a control block diagram of a main portion of the projector in the present embodiment.

Referring to FIG. 2, the projector includes first lamp 10A, second lamp 10B, a lamp ballast unit 400 for supplying electric power of a high voltage to these lamps, a main unit 100 including a single or a plurality of control boards, a mirror unit 200, a relay unit 300, and an input device 500.

Main unit 100 includes a CPU (Central Processing Unit) 110 for entirely controlling the operation of the projector.

Input device 500 receives external manipulation performed on the input device. Input device 500 may be, for example, a button provided on the surface of the casing covering the outside of the projector, or may be a soft key of a remote controller provided separately from the casing or a button on a touch panel. When input device 500 is manipulated, information about the manipulation is input from input device 500 to CPU 110.

Mirror unit 200 includes, in addition to mirror 10D as described above, a drive mechanism (not shown) for driving mirror 10D. Mirror unit 200 also includes a first detection switch 201 for detecting whether or not mirror 10D is in a state of directing the light emitted from first lamp 10A to prism 20, and a second detection switch 202 for detecting whether or not mirror 10D is in a state of directing the light emitted from second lamp 10B to prism 20. First detection switch 201 and second detection switch 202 detect the state of mirror 10D, independently of CPU 110. Here, “independently of CPU 110” means that detection by first detection switch 201 and second detection switch 202 is not influenced by operation of CPU 110.

Regarding mirror 10D, the state where the mirror directs the light emitted from first lamp 10A to prism 20 is herein referred to as first state, and the state where the mirror directs the light emitted from second lamp 10B to prism 20 is herein referred to as second state.

Relay unit 300 includes a first relay 301 for making a switch between the opened state and the closed state of electrical connection between lamp ballast unit 400 and first lamp 10A, and a second relay 302 for making a switch between the opened state and the closed state of electrical connection between lamp ballast unit 400 and second lamp 10B.

First relay 301 and second relay 302 are each configured as an electromagnetic relay. The relays of the present embodiment, however, are not limited to the electromagnetic relay, and may be configured as a static relay.

When first detection switch 201 closes the circuit, first relay 301 assumes the state of being supplied with drive electric power from a first relay power supply 121 via first detection switch 201. When mirror 10D assumes the above-described first state, first detection switch 201 is closed.

In other words, when mirror 10D assumes the first state, first detection 201 closes the electrical circuit connecting first relay power supply 121 and first relay 301, and accordingly electric power is supplied from first relay power supply 121 to first relay 301. When CPU 110 outputs a signal for closing the circuit (first relay control signal: H), first relay 301 supplied with electric power closes the electrical circuit connecting lamp ballast unit 400 and first lamp 10A. Accordingly, the electric power is supplied to first lamp 10A.

As for second relay 302, when second detection switch 202 closes the circuit, second relay 302 assumes the state of being supplied with drive electric power from a second relay power supply 122 via second detection switch 202. Second detection switch 202 is closed when mirror 10D assumes the above-described second state.

In other words, when mirror 10D assumes the second state, second detection switch 202 closes the electrical circuit connecting second relay power supply 122 and second relay 302, and accordingly electric power is supplied from second relay power supply 122 to second relay 302. When CPU 110 outputs a signal for closing the circuit (second relay control signal: H), second relay 302 supplied with electric power closes the electrical circuit connecting lamp ballast unit 400 and second lamp 10B. Accordingly, the electric power is supplied to second lamp 10B.

Lamp ballast unit 400 is configured to be able to communicate with CPU 110. CPU 110 communicates with lamp ballast unit 400 to detect, for example, the electric power supplied by lamp ballast unit 400 and detect whether or not abnormality occurs to lamp ballast unit 400 based on the result of detection. The result of detection is processed in CPU 110, and reflected on a ballast control signal from an AND circuit 153 to lamp ballast unit 400 as described below. In FIG. 2, the result of detection by CPU 110 is shown as “result of ballast abnormality detection”. The result of ballast abnormality detection is represented by value H when the lamp ballast unit operates normally (namely abnormality is not detected), and represented by value L when abnormality is detected.

Main unit 100 includes a voltage level shift buffer 131 for detecting whether or not electric power is supplied to first relay 301, based on whether first detection switch 201 is opened or closed. Main unit 100 also includes a voltage level shift buffer 132 for detecting whether or not electric power is supplied to second relay 302, based on whether second detection switch 202 is opened or closed.

Respective outputs representing the results of detection by voltage level shift buffer 131 and voltage level shift buffer 132 are input respectively as a first detection signal and a second detection signal to CPU 110. These detection signals are also input to a NAND circuit 151. The result of operation performed by NAND circuit 151 is output as monitoring result A to AND circuit 153.

In other words, in the present embodiment, the first detection signal and the second detection signal are input to CPU 110 and also input to NAND circuit 151 performing operation independently of CPU 110, and the result of the operation by the NAND circuit is output to AND circuit 153. Here, “independently of CPU 110” means that the operation by NAND circuit 151 is not influenced by operation of CPU 110.

CPU 110 executes a program stored in a memory 111 to perform various control processes. The program may have been recorded in memory 111 at the time of shipment of the projector, or may be downloaded via a network or the like to be recorded in memory 111 if the projector has the communication capability, or the program recorded on a recording medium provided separately from the projector may be written to be recorded in memory 111 if the projector can read information recorded on such a recording medium.

When CPU 110 is to cause first lamp 10A to be turned on, based on input for example of information provided externally via input device 500, CPU 110 outputs a control signal to mirror unit 200 so that mirror 10D assumes the first state, and performs a process for turning on first lamp 10A.

Specifically, in the process for turning on first lamp 10A, CPU 110 outputs a first relay control signal for closing first relay 301, and outputs a ballast control signal to lamp ballast unit 400 for causing lamp ballast unit 400 to supply electric power to relay unit 300.

The first relay control signal is herein a signal which is output from CPU 110 to relay unit 300 for instructing whether first relay 301 is to be opened or closed, and assumes one of value H (High) and value L (Low). The H signal is used for turning on first relay 301 to cause first relay 301 to close the circuit. The L signal is used for causing first relay 301 to open the circuit.

The second relay control signal is herein a signal which is output from CPU 110 to relay unit 300 for instructing whether second relay 302 is to be opened or closed, and assumes one of value H and value L. The H signal is used for turning on second relay 302 to cause second relay 302 to close the circuit. The L signal is used for causing second relay 302 to open the circuit.

The first relay control signal and the second relay control signal that are output from CPU 110 are provided to relay unit 300 and also provided to a NAND circuit 152. NAND circuit 152 performs operation on these signals, and outputs the result of operation as monitoring result B to AND circuit 153.

When CPU 110 is to cause first lamp 10A or second lamp 10B to be turned on, CPU 110 outputs the ballast control signal. The ballast control signal is a control signal for lamp ballast unit 400 and is output from CPU 110 to AND circuit 153. The ballast control signal assumes one of value H and value L. The H signal is used for causing lamp ballast unit 400 to supply electric power to relay unit 300. The L signal is used for stopping supply of the electric power. The ballast control signal output from CPU 110 is provided as monitoring result C to the AND circuit.

AND circuit 153 receives input of monitoring result A, monitoring result B and monitoring result C, performs operation on them and outputs the H or L signal based on the result of the operation. The signal that is output from the AND circuit is input to lamp ballast unit 400.

When the signal that is input from AND circuit 153 is the H signal, lamp ballast unit 400 supplies electric power to relay unit 300, and stops supply of the electric power when the signal is the L signal.

Table 1 shows examples of the first detection signal and the second detection signal.

TABLE 1
States of detection signals corresponding to respective detection
outputs from detection switches in mechanical control system

| | first | second | first | second |
|---|---|---|---|---|
| | detection | detection | detection | detection |
| state of mirror | switch | switch | signal | signal |
| first lamp side | ON | OFF | H | L |
| during being | OFF | OFF | L | L |
| switched | | | | |
| second lamp side | OFF | ON | L | H |

When first detection switch 201 is ON, namely mirror 10D assumes the first state, the first detection signal has value H. Otherwise, the first detection signal has value L.

When mirror 10D assumes the second state, the second detection signal has value H. Otherwise, the second detection signal has value L.

An example of switching between the first state and the second state of mirror 10D will be described with reference to Table 1. Specifically, how the first detection signal and the second detection signal change when the state of mirror 10D is switched from the first state to the second state will be described.

When mirror 10D assumes the first state (“first lamp side” in Table 1) for directing the light generated by first lamp 10A to prism 20, first detection switch 201 is ON while second detection switch 202 is OFF, and accordingly the first detection signal has level H while the second detection signal has level L.

While mirror 10D is being switched from the first state to the second state (“during being switched” in Table 1), the mirror 10D is neither in the first state nor in the second state, so that both of first detection switch 201 and second detection switch 202 are OFF. Accordingly, both of the first detection signal and the second detection signal have level L.

When mirror 10D reaches the second state (“second lamp side” in Table 1), first detection switch 201 remains OFF while second detection switch 202 is made ON.

Accordingly, in this state, the first detection signal has level L while the second detection signal has level H.

A relation between input signals to NAND circuit 151 and the result of operation by NAND circuit 151 will be described with reference to Table 2.

TABLE 2
Relation between detection signals and monitoring
result in electrical control system

| first | second | |
|---|---|---|
| detection | detection | monitoring |
| signal | signal | result A |
| L | L | H (normal) |
| H | L | H (normal) |
| L | H | H (normal) |
| H | H | L (abnormal) |

Referring to Table 2, when the combination of the first detection signal and the second detection signal that are input to NAND circuit 151 is that both of the signals have level L or one of the signals has level H and the other has level L, NAND circuit 151 outputs H as monitoring result A to AND circuit 153. When both of the first detection signal and the second detection signal have level H, NAND circuit 151 outputs L as monitoring result A to AND circuit 153.

The state where both of the first detection signal and the second detection signal have level H corresponds to the state where both of first detection switch 201 and second detection switch 202 are ON, and accordingly mirror 10D assumes both of the first state and the second state.

Mirror 10D rotates to assume one of the first state and the second state, and cannot assume both of the first state and the second state at the same time.

Thus, when both of the first detection signal and the second detection signal have level H, namely it is suggested that mirror 10D assumes both of the first state and the second state, NAND circuit 151 outputs L as monitoring result A indicating that an abnormality occurs.

Referring next to Table 3, a relation between input signals to NAND circuit 152 and the result of operation by NAND circuit 152 will be described.

TABLE 3
Relation between relay control signals and monitoring
result in electrical control system

| first relay | second relay | monitoring |
|---|---|---|
| control signal | control signal | result B |
| L | L | H (normal) |
| H | L | H (normal) |
| L | H | H (normal) |
| H | H | L (abnormal) |

Referring to Table 3, when both of the first relay control signal and the second relay control signal have level L or one of the signals has level L and the other has level H, NAND circuit 152 determines that the relays are controlled normally and accordingly outputs level H. When both of the first and second relay control signals have level H, NAND circuit 152 determines that abnormality occurs to control for the relays, and accordingly outputs level L.

The projector of the present embodiment is configured so that mirror 10D can direct only one of the light generated by first lamp 10A and the light generated by second lamp 10B. Electric power is thus supplied from lamp ballast unit 400 to one of first lamp 10A and second lamp 10B. The fact that both of the first relay control signal and the second relay control signal have level H, however, suggests that the control signals are output to cause both of first relay 301 and second relay 302 to be closed.

In such a case, NAND circuit 152 outputs L to AND circuit 153. Otherwise, NAND circuit 152 outputs H to AND circuit 153 as monitoring result B.

Details concerning the ballast control signal that is output from CPU 110 will now be described.

CPU 110 determines, based on, for example, input from input device 500 as described above, whether to turn on first lamp 10A or second lamp 10B, and outputs the first and second relay control signals and then outputs the ballast control signal, so that the lamp that should be turned on as determined by CPU 110 is turned on. CPU 110 generates the ballast control signal based on the states of the first detection signal and the second detection signal and the result of the ballast abnormality detection. The states of the ballast control signal as generated are shown in Table 4.

TABLE 4
Ballast control signal (monitoring result C) output from CPU

| first | second | result of ballast | |
|---|---|---|---|
| detection | detection | abnormality | monitoring |
| signal | signal | detection | result C |
| L | L | H | H (normal) |
| H | L | H | H (normal) |
| L | H | H | H (normal) |
| H | H | H | L (abnormal) |
| L | L | L | L (abnormal) |
| H | L | L | L (abnormal) |
| L | H | L | L (abnormal) |
| H | H | L | L (abnormal) |

Referring to Table 4, when both of the first detection signal and the second detection signal have level L and the result of the ballast abnormality detection is H, namely mirror 10D assumes neither the first state nor the second state and the result of the ballast abnormality detection indicates the normal state, the ballast control signal has level H.

When one of the first detection signal and the second detection signal has level H and the other has level L and the result of the ballast abnormality detection is H, namely, it is detected that mirror 10D assumes one of the first state and the second state and the result of the ballast abnormality detection indicates the normal state, the ballast control signal has level H as well.

In contrast, when both of the first detection signal and the second detection signal have level H, it is suggested that mirror 10D assumes the first state and also the second state. In this case, an abnormal state occurs and the ballast control signal has level L. Further, when the result of the ballast abnormality detection is L, the state of lamp ballast unit 400 is inappropriate for turning on the lamp. This state is regarded as abnormal and the ballast control signal has level L.

A relation between the ballast control signal that is output from AND circuit 153 and monitoring results A to C as described above will now be described with reference to Table 5.

TABLE 5
Ballast control signal output from AND circuit (monitoring
results in Tables 2 to 4 and ballast control signal)

| monitoring | monitoring | monitoring | ballast control |
|---|---|---|---|
| result A | result B | result C | signal |
| H | H | H | H (turn on) |
| L | H | H | L (turn off) |
| H | L | H | L (turn off) |
| H | H | L | L (turn off) |
| L | L | H | L (turn off) |
| L | H | L | L (turn off) |
| H | L | L | L (turn off) |
| L | L | L | L (turn off) |

Referring to Table 5, AND circuit 153 outputs the ballast control signal of H to lamp ballast unit 400, only when all of monitoring results A to C have level H. Namely, only when all of NAND circuit 151, NAND circuit 152 and CPU 110 detect no abnormality, AND circuit 153 permits lamp ballast unit 400 to supply electric power to relay unit 300.

In the present embodiment as heretofore described, when CPU 110 outputs the ballast control signal, the control signal is not directly input to lamp ballast unit 400 but input to AND circuit 153 as monitoring result C. Further, to AND circuit 153, the result of detection (monitoring result A) of the state of mirror 10D, based on respective results of detection by first detection switch 201 and second detection switch 202, is input from NAND circuit 151. Further, to AND circuit 153, the state of control signals (monitoring result B) concerning control of opening and closure of first relay 301 and second relay 302 that are output from CPU 110 to relay unit 300 is input from NAND circuit 152. Only when all of monitoring results A to C that are input to AND circuit 153 represent respective states appropriate for supplying electric power from lamp ballast unit 400 to relay unit 300, AND circuit 153 outputs a signal for instructing lamp ballast unit 400 to supply electric power.

In the present embodiment, CPU 110 that outputs the ballast control signal is a component of a control unit for controlling the manner of supplying electric power to first lamp 10A or second lamp 10B.

First detection switch 201 and second detection switch 202 that output respective results of detection based on which monitoring result A is generated, as well as NAND circuit 152 that outputs monitoring result B, perform the detection independently of CPU 110 that outputs monitoring result C, and accordingly output respective signals. Thus, in the present embodiment, first detection switch 202 and second detection switch 202, NAND circuit 151 that outputs monitoring result A based on respective detection outputs from these switches, and NAND circuit 152 that outputs monitoring result B are components of a detection unit.

In the present embodiment, a CPU control system 901 including memory 111 and CPU 110 for outputting the ballast control signal from CPU 110, an electrical control system 902 including NAND circuit 151 and NAND circuit 152 for providing monitoring results B and C independently of CPU 110, and a mechanical control system 903 for detecting the physical state of mirror 10D are combined to implement control of electric power feeding to relay unit 300, namely electric power feeding to first lamp 10A and second lamp 10B.

In the image display apparatus according to the present invention, the entire system is configured to include different control systems independent of each other, so that erroneous supply of electric power from lamp ballast unit 400 to relay unit 300 can be avoided even if a signal is erroneously transmitted by CPU 110.

The configuration of the entire system of the image display apparatus according to the present invention is not limited to such a combination of different control systems. The entire system may be configured to include a plurality of control systems of the same type, such as a plurality of CPUs, namely the system may be configured to include multiplexed control systems.

Further, in the present embodiment, although only NAND circuits are used as logical circuits that output monitoring result A and monitoring result B, respectively, other circuits may be used. An example will be described where the electrical control system operating independently of CPU 110 includes an EXOR circuit that outputs both of the monitoring results.

In the case where NAND circuit 151 is used, monitoring result A has level H when one of the first detection signal and the second detection signal has level L as shown in Table 2. In the case where the EXOR circuit is used as a logical circuit that outputs monitoring result A, monitoring result A has level H only when both of the first detection signal and the second detection signal have level L.

In the case where NAND circuit 152 is used, monitoring result B has level H when one of the first relay control signal and the second relay control signal has level L as shown in Table 3. In the case where the EXOR circuit is used as a logical circuit that outputs monitoring result B, monitoring result B has level H only when both of the first relay control signal and the second relay control signal have level L.

It is supposed here that control has to be performed so that lamps (first lamp 10A and second lamp 10B) are turned off. Even if monitoring result C is H due to electromagnetic noise occurring to CPU 110 or other circuits in the projector or due to malfunction of CPU 110, monitoring result A and monitoring result B generated in the above-described manner have level L. Accordingly, the ballast control signal that is output from AND circuit 153 has level L and thus AND circuit 153 can perform control so that the lamps are turned off.

In this way, even if such an event as described above occurs, erroneous supply of electric power to relay unit 300 can be avoided.

An example of the above-described case where control has to be performed so that the lamps are turned off may refer to a period, for example, in which mirror 10D is being rotated or contacts of a relay (first relay 301 or second relay 302) are opened.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image display apparatus comprising:
an illumination device;
a power supply unit for supplying electric power to said illumination device;
a control unit for controlling a manner of supplying electric power from said power supply unit to said illumination device;
a detection unit independent of said control unit for detecting whether a component of said image display apparatus assumes a state satisfying a condition on which electric power is supplied to said illumination device; and
a permission unit permitting supply of electric power to said illumination device when said control unit outputs to said power supply unit a signal for causing said power supply unit to supply electric power to said illumination device and said detection unit detects that said component assumes said state satisfying said condition.

2. The image display apparatus according to claim 1, further comprising a relay for making a switch between an opened state and a closed state of an electric circuit between said power supply unit and said illumination device, wherein
said detection unit detects whether said control unit outputs a signal for causing said relay to be closed, and
said permission unit permits supply of electric power from said power supply unit to said illumination device on condition that said control unit outputs to said power supply unit said signal for causing said power supply unit to supply electric power to said illumination device and that said detection unit detects that said control unit outputs said signal for causing said relay to be closed.

3. The image display apparatus according to claim 2, wherein
said component is an optical component for directing light generated by said illumination device to an outside,
said detection unit determines whether said optical component assumes an appropriate state for directing the light generated by said illumination device to the outside, and
said permission unit permits supply of electric power from said power supply unit to said illumination device on condition that said optical component assumes said appropriate state.

4. The image display apparatus according to claim 3, wherein
said relay is supplied with electric power for keeping said electric circuit closed on condition that said optical component assumes said appropriate state.

5. A method of controlling an image display apparatus including an illumination device, a power supply unit for supplying electric power to said illumination device and a control unit for controlling a manner of supplying electric power from said power supply unit to said illumination device, said method comprising the steps of:
determining whether said control unit outputs to said power supply unit a signal for causing said power supply unit to supply electric power to said illumination device;
detecting whether a component of said image display apparatus assumes a state satisfying a condition on which electric power is supplied to said illumination device, by means of a control system independent of said control unit; and
supplying electric power from said power supply unit to said illumination device when said control unit outputs said signal to said power supply unit and said component assumes said state satisfying said condition.
